(19) United States
(12) Patent Application Publication
(10) Pub. No.: US 2004/0221076 A1
(43) Pub. Date: Nov. 4, 2004

(54) Method for numbering peripheral devices mounted on a machine, particularly for knitting machines

(76) Inventor: Riccardo Lonati, Brescia (IT)

Correspondence Address: MODIANO & ASSOCIATI, Via Meravigli, 16, 20123 MILANO, IT

(21) Appl. No.: 10/827,259

(22) Filed: Apr. 20, 2004

(30) Foreign Application Priority Data
Apr. 30, 2003 (IT) MI2003A000893

(51) Int. Cl. G06F 3/00

(52) U.S. Cl. 710/72

(57) ABSTRACT

A method for numbering peripheral devices mounted on a knitting machine, comprising the steps of:

communicating, on the part of each peripheral device, its own universal address assigned uniquely during production;

transmitting, on the part of the machine, to each peripheral device, an incremental logic address once reception of the universal addresses has ended;

associating, on the part of a user of the machine, an identification number of each peripheral device to be linked to the logic address;

the automatic numbering of the peripheral devices occurring by communicating with the machine over a serial line.

The present invention relates to a method for numbering peripherals for communication with a master, particularly in knitting machines. The invention relates more particularly to a method for numbering peripheral devices, such as for example thread motion status sensors of a knitting machine, that allows to identify the sensors and allows them to communicate with a master device that is capable of recognizing the information that arrives from the sensors and from which of the sensors the information is arriving.

### BACKGROUND OF THE INVENTION

As is known, knitting machines have a plurality of peripheral devices, such as for example thread motion status sensors or thread feeders, which are connected by means of the serial line to a host system, known as master, which interfaces with a microcontroller inserted in the sensor.

The fact of being able to number and then identify the various sensors or in general any other peripheral, such as for example a thread feeder, is particularly important in the field of knitting machines, particularly in circular hosiery knitting machines, since in this manner it is possible to discriminate the various items of information that reach the host system, so as to understand exactly whether there is a machine problem and where such problem is located.

The background art allows sequential numbering of the devices by direct intervention on the sensor (e.g., by pressing a button). In this manner, numbering necessarily occurs ordinally and does not allow automatic association with the machine element that is linked (for production) to the device being considered. Accordingly, the following drawbacks are noted:

exclusively sequential and ordinal automatic numbering, which does not allow gaps (to exclude a device, it is necessary to mount it, number it, then unmount it or exclude it).

association with devices that are linked for production is an additional operation that is not automatic in numbering.

### SUMMARY OF THE INVENTION

The aim of the present invention is to provide a method for numbering peripheral devices that communicate with a host system, particularly for knitting machines, that allows to number efficiently and uniquely each peripheral device so that it can, by communicating with the host system, be determined uniquely by said system.

Within this aim, an object of the present invention is to provide a method for numbering peripheral devices for communication with a host system, particularly for knitting machines, in which numbering is performed automatically.

Another object of the present invention is to provide a method for automatic numbering of peripheral devices in which communication between the peripheral devices and the host system occurs by means of a serial line.

Another object of the present invention is to provide a method for numbering peripheral devices that communicate with a host system that is highly reliable, relatively simple to provide, and at competitive costs.

This aim and these and other objects that will become better apparent hereinafter are achieved by a method for numbering peripheral devices mounted on a knitting machine, characterized in that it comprises the steps of:

communicating, on the part of each peripheral device, a universal address belonging to said peripheral device and assigned uniquely during production;

transmitting, on the part of said machine, to each peripheral device, an incremental logic address once reception of said universal addresses has ended;

associating, on the part of a user of the machine, an identification number of each peripheral device to be linked to said logic address;

said automatic numbering of said peripheral devices occurring by communicating with the machine over a serial line.

Further characteristics and advantages of the invention will become better apparent from the description of a preferred but not exclusive embodiment of the method according to the present invention, which is as follows.

### DESCRIPTION OF THE PREFERRED EMBODIMENTS

In the following, reference will be made to peripheral devices in the form of thread status sensors, but obviously such description must be understood as being suitable for any peripheral device that communicates with a host system.

Each peripheral device (for example a thread sensor) is identified by means of an incremental logic address, which is assigned to it during the numbering step by the host system. Before numbering, the peripheral device can instead be identified by way of a universal address that is assigned to it at production time. Substantially, since more than one peripheral device can be mounted on a same machine, the host, i.e., the machine proper, must be able to identify individual peripheral devices.

The automatic numbering to which the present method relates allows the host to assign an incremental logic address to the peripheral device, allows the user to associate a peripheral device identification number and optionally even an element of the machine, such as for example in the case of a sensor, a thread guide and a drop.

The host must deal with not allowing the user to associate an identification number that has already been assigned to a previous sensor.

Substantially, the method is as follows.

The machine sends a common numbering request message to all the peripheral devices. Upon receiving the message, each peripheral device triggers the automatic numbering procedure and notifies the status to the user by means of an appropriate signal, for example by flashing an appropriately provided LED, while keeping another one switched off.

Each peripheral device begins the numbering procedure by sending its own universal address; this operation, which is performed by the peripheral devices, avoiding conflicts on the serial line to ensure that the host receives all the universal addresses.

When the transmission of the universal address from each peripheral device to the host or master has ended, the master sends the universal address to each peripheral device, one by one, followed by an incremental logic address.

The peripheral device that receives its universal address from the master flashes an LED that is different from the previously indicated LED, switching off the latter, and this indication is used by the user to see which sensor or peripheral in general is selected and therefore to associate with such sensor a sensor identification number and optionally a thread guide and a drop.

In this manner, the host performs automatic numbering of the different sensor devices, at the same time allowing the user to associate a particular identification number with each peripheral device, uniquely to one or more elements of the knitting machine.

The automatic numbering of the peripheral devices allows the host to identify which of the peripheral devices is communicating with it, thus allowing the user to realize easily whether there is a problem in a given point in the machine in which a given sensor or peripheral device is located.

In the case of a thread sensor, it must be noted that the threads are electrostatically charged: the distribution and quantity of the charges depends on the physical nature of the thread and is not uniform along the thread. The extent and distribution of the charges on the thread are measured at each instant, so as to recognize the presence or absence of thread or its motion and speed, if any.

The measurement is performed with a charge analysis circuit, which is managed by a microcontroller, which is integrated in the sensor and is capable of calibrating the measurement according to variations of the ambient conditions and the thread. This maximizes the efficiency of the sensor.

The sensor is connected, by way of the serial line, to the master, which interfaces with the microcontroller inserted in the sensor.

The software that is present on board the microcontroller of the sensor is capable of reading the data transmitted over the serial line and of detecting incorrect transmissions caused by line noise or by transmission collisions with other sensors. In order to be able to perform this operation, the software must keep enabled both the transmission lines and the receiving lines.

At each transmission, the software checks the echo and continues to try again until a positive outcome is achieved (any problems on the serial line must be detected and reported by the master by using space-time deadlines).

The receiving line is also connected to an interrupt of the microprocessor, in order to establish instantaneously whether a communication is already in progress over the serial line.

In practice it has been found that the automatic number method according to the present invention fully achieves the intended aim and objects, since it allows to number each peripheral device, so that the master can then identify which peripheral device is communicating over the serial line, so that the user can realize immediately which peripheral device has a problem or is transmitting relevant information regarding the status of the machine.

The method thus conceived is susceptible of numerous modifications and variations, all of which are within the scope of the appended claims; all the details may further be replaced with other technically equivalent elements.

The disclosures in Italian Patent Application No. MI2003A000893 from which this application claims priority are incorporated herein by reference.

What is claimed is:

1. A method for numbering peripheral devices mounted on a knitting machine, comprising the steps of:
communicating, on the part of each peripheral device, a universal address belonging to said peripheral device and assigned uniquely during production;
transmitting, on the part of said machine, to each peripheral device, an incremental logic address once reception of said universal addresses has ended;
associating, on the part of a user of the machine, an identification number of each peripheral device to be linked to said logic address;
said automatic numbering of said peripheral devices occurring by communicating with the machine over a serial line.

2. The method according to claim 1, comprising the additional step of verifying, by said machine, that said identification number assigned by the user to a peripheral device has not been already assigned to another peripheral device.

3. The method according to claim 1, comprising the additional step of assigning, by said user, together with said identification number, one or more elements of said machine to said peripheral device.

4. The method according to claim l, wherein said peripheral device is a thread status sensor.

5. The method according claim 1, wherein said peripheral device is a thread feeder.

6. The method according to claim 1, wherein said peripheral device is any device that is present on the machine in more than one unit.
